(19) United States
(12) Patent Application Publication
(10) Pub. No.: US 2024/0317401 A1
(43) Pub. Date: Sep. 26, 2024

(54) LATCH SOLENOID ACTUATED FULLY AUTOMATIC AUXILIARY GUIDE ASSEMBLY

(71) Applicant: GOODRICH CORPORATION, Charlotte, NC (US)

(72) Inventors: ELVIS JACK PEREIRA, Bangalore (IN); Sayooj Adavalath Puthiyaveettil, Bangalore (IN)

(73) Assignee: GOODRICH CORPORATION, Charlotte, NC (US)

(21) Appl. No.: 18/319,992

(22) Filed: May 18, 2023

(30) Foreign Application Priority Data
Mar. 21, 2023 (IN) 202341019370

(51) Int. Cl. B64D 9/00

(52) U.S. Cl. CPC B64D 9/003; B64D 2009/006

(57) ABSTRACT

An auxiliary guide assembly is disclosed. The auxiliary guide assembly including a head including a guiding surface and an overriding surface, a pinion, a hub configured to receive the pinion, a union unit configured to secure the pinion to the hub, the union unit rotationally coupled to the pinion and the head, a solenoid coupled to the hub, the solenoid configured to receive a first electric polarity, a reciprocating rod disposed through the solenoid, the reciprocating rod having a first rod end including a rack operatively coupled to the pinion, and an armature adjacent the solenoid and configured to engage the reciprocating rod, the armature moves in a first direction in response to the solenoid receiving the first electric polarity, the armature moving the reciprocating rod in the first direction, and the head rotates in a second direction in response to the reciprocating rod moving in the first direction.

### CROSS-REFERENCE TO RELATED APPLICATIONS

This application claims priority to, and the benefit of, India Patent Application No. 202341019370 (DAS CODE: 8CES), filed Mar. 21, 2023, and titled “LATCH SOLENOID ACTUATED FULLY AUTOMATIC AUXILIARY GUIDE ASSEMBLY,” which is incorporated by reference herein in its entirety for all purposes.

### FIELD

The present disclosure generally relates to cargo guide assemblies, and more specifically, to automatic auxiliary guide assemblies.

### BACKGROUND

Auxiliary guides are used in air cargo compartments with the cargo surface, such as a ball panel, near the cargo loading door of an aircraft. Auxiliary guides aid in guiding and stopping unit load devices (ULDs) in the cargo compartment. To accomplish this, auxiliary guides generally have two guiding surfaces in a longitudinal direction of the aircraft and two overriding surfaces in a lateral direction of the aircraft. The auxiliary guides are manually engaged and disengaged.

### SUMMARY

An auxiliary guide assembly is disclosed herein. The auxiliary guide assembly includes a head including a guiding surface and an overriding surface, a pinion, a hub configured to receive the pinion, a union unit configured to secure the pinion to the hub, the union unit rotationally coupled to the pinion and the head, a solenoid coupled to the hub, the solenoid configured to receive a first electric polarity, a reciprocating rod disposed through the solenoid, the reciprocating rod having a first rod end including a rack operatively coupled to the pinion, and an armature disposed adjacent the solenoid and configured to engage the reciprocating rod, wherein the armature is configured to move in a first direction in response to the solenoid receiving the first electric polarity, the armature moving the reciprocating rod in the first direction, and the head is configured to rotate in a second direction in response to the reciprocating rod moving in the first direction.

In various embodiments, the solenoid is further configured to receive a second electric polarity that is opposite the first electric polarity, wherein the armature is configured to move in a third direction that is opposite the first direction in response to the solenoid receiving the second electric polarity, and the head is configured to rotate in a fourth direction in response to the armature moving in the second direction, the fourth direction being opposite the second direction. In various embodiments, the auxiliary guide assembly further includes an inner spring disposed between the armature and the solenoid, the inner spring configured to move the armature in a third direction that is opposite the first direction and a ring magnet configured to hold the armature in first position.

In various embodiments, the auxiliary guide assembly further includes a first opening in the head having a first rectangular cross section, a second opening in the hub having a circular cross section, and a third opening in the pinion having a second rectangular cross section, the union unit disposed through the first opening, the second opening, and the third opening. In various embodiments, the auxiliary guide assembly further includes a rod head disposed at a second rod end of the reciprocating rod that is opposite the first rod end and an outer spring disposed between the rod head and the armature, wherein the outer spring is configured to move the rod head in a third direction that is opposite the first direction.

In various embodiments, the union unit further includes a body having a first end, a second end, and a first side extending from the first end to the second end, a first opening in the first end, a second opening in the second end, a first lock pin disposed in the first opening, and a second lock pin disposed in the second opening, wherein the first lock pin and the second lock pin are configured to engage the head. In various embodiments, the first lock pin has a first portion and a second portion, the first portion having a circular cross section and the second portion having a rectangular cross section.

Also disclosed herein is a cargo handling system including a ball panel for moving and storing cargo, the ball panel having a top surface and an auxiliary guide assembly disposed within the ball panel. The auxiliary guide assembly includes a head configured to rotate in a first direction to extend above the top surface and rotate in a second direction to retract below the top surface, the second direction being opposite the first direction, a rack and pinion coupled to the head, the pinion causing the head to rotate in the first direction and the second direction, and a solenoid magnetically coupled to the rack, the solenoid causing the rack to move in a first linear direction and a second linear direction, wherein the head rotates in the first direction in response to the rack moving in the first linear direction.

In various embodiments, the auxiliary guide assembly further includes a reciprocating rod coupled to the rack, the reciprocating rod extending through the solenoid, an armature configured to engage the reciprocating rod, the armature disposed adjacent the solenoid wherein the solenoid is configured to move the armature in the first linear direction in response to a first electric polarity, and an inner spring disposed between the solenoid and the armature, the inner spring configured to move the armature in the second linear direction.

In various embodiments, the auxiliary guide assembly further includes a rod head coupled to the reciprocating rod and an outer spring disposed between the rod head and the armature, the outer spring configured to move the rod head in the second linear direction. In various embodiments, the auxiliary guide assembly further includes a ring magnet disposed between the solenoid and the armature, the ring magnet configured to hold the armature in a first position in response to the solenoid receiving the first electric polarity.

In various embodiments, the solenoid is configured to move the armature in the second linear direction in response to a second electric polarity that is opposite the first electric polarity. In various embodiments, the rack moves in the second linear direction in response to the head rotating in the second direction. In various embodiments, the auxiliary guide assembly further includes a hub configured to receive the pinion and a union unit coupled to the hub, the pinion, and the head, wherein the union unit is rotationally coupled to the pinion and the head.

Also disclosed herein is a system including a ball panel having a top surface, a first auxiliary guide assembly disposed in the ball panel, the first auxiliary guide assembly including a head configured to raise above the top surface and retract below the top surface, a user interface, a processor operatively connected to the first auxiliary guide assembly and to the user interface, and a memory operatively coupled to the processor. The memory includes instructions stored thereon that, when executed by the processor, cause the processor to receive a first instruction from the user interface and send a first electric polarity to the first auxiliary guide assembly in response to the first instruction, the head raising above the top surface in response to the first electric polarity.

In various embodiments, the instructions, when executed by the processor, further cause the processor to receive a second instruction from the user interface and send a second electric polarity to the first auxiliary guide assembly in response to the second instruction, the head retracting below the top surface in response to the second electric polarity, the second electric polarity being opposite the first electric polarity. In various embodiments, the first auxiliary guide assembly further includes a solenoid configured to receive the first electric polarity, a rack magnetically coupled to the solenoid, the rack configured to move linearly in a first direction in response to the solenoid receiving the first electric polarity, and a pinion coupled to the head and the rack, the pinion translating a linear motion of the rack to a rotational motion of the head.

In various embodiments, the first auxiliary guide assembly further includes a reciprocating rod coupled to the rack and extending through the solenoid, a ring magnet disposed adjacent the solenoid, and an armature configured to engage the reciprocating rod, the armature configured to move in the first direction to a first position in response to the solenoid receiving the first electric polarity, the ring magnet holding the armature in the first position in an absence of the first electric polarity.

In various embodiments, the system further includes a second auxiliary guide assembly disposed in the ball panel and the processor is operatively coupled to the second auxiliary guide assembly. The instructions, when executed by the processor, further cause the processor to receive a second instruction from the user interface, the second instruction identifying the second auxiliary guide assembly and send the first electric polarity to the second auxiliary guide assembly independent of the first auxiliary guide assembly. In various embodiments, the user interface is configured to engage and disengage the first auxiliary guide assembly and the second auxiliary guide assembly.

The foregoing features and elements may be combined in any combination, without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates a schematic of an aircraft being loaded with cargo, in accordance with various embodiments.

FIGS. 2A and 2B illustrate a cargo handling system including auxiliary guide assemblies, in accordance with various embodiments.

FIGS. 3A, 3B, 3C, and 3D illustrate a cargo handling system including an auxiliary guide assembly guiding a unit load device, in accordance with various embodiments.

FIGS. 4A, 4B, 4C, 4D, 4E, and 4F illustrate an auxiliary guide assembly, in accordance with various embodiments.

FIGS. 5A, 5B, and 5C illustrate the operation of an auxiliary guide assembly, in accordance with various embodiments.

FIG. 6 illustrates a system for controlling a plurality of auxiliary guide assemblies, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. While these exemplary embodiments are described in sufficient detail to enable those skilled in the art to practice the invention, it should be understood that other embodiments may be realized and that logical, chemical and mechanical changes may be made without departing from the spirit and scope of the invention. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

Disclosed herein is a fully automated auxiliary guide assembly. The auxiliary guide assembly includes a head having two guiding surfaces and two override surfaces in the lateral and axial directions. The head is coupled to a hub that supports a pinion and a solenoid assembly. In various embodiments, the solenoid assembly houses a solenoid, a reciprocating rod, an inner spring, a ring magnet, and an armature. In various embodiments, the head is configured to be rotationally coupled to the pinion. In various embodiments, the pinion is configured to engage a rack that is coupled to the reciprocating rod. In various embodiments, the armature is configured to move in a first direction, being attracted to the solenoid when the solenoid is powered by a first electric polarity, and held in place by the ring magnet. In various embodiments, the armature is configured to engage the reciprocating rod and move the reciprocating rod in a first direction, thereby rotating the pinion and the head to a closed position. In various embodiments, the solenoid, when powered by a second electric polarity that is different than the first electric polarity, moves the armature in a second direction that is opposite the first direction. In various embodiments, the reciprocating rod is able to move freely in the first direction and the second direction to raise and lower the head 212.

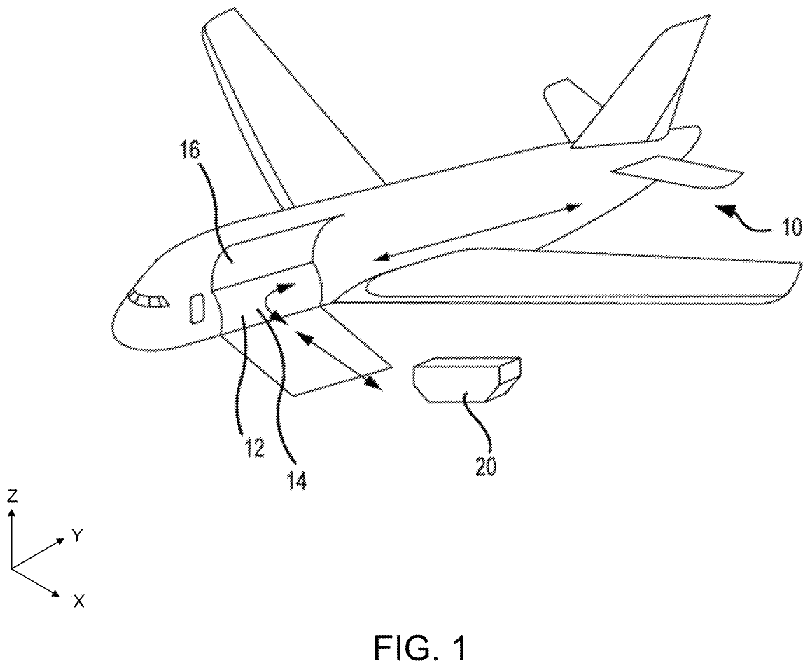

Referring now to FIG. 1, in accordance with various embodiments, a perspective view of an aircraft 10 is illustrated. Aircraft 10 includes a cargo deck 12 located within a cargo compartment 14. Aircraft 10 may comprise a cargo load door 16 located, for example, at one side of a fuselage structure of aircraft 10. A unit load device (ULD) 20, in the form of a container or pallet, for example, may be loaded through cargo load door 16 and onto cargo deck 12 of aircraft 10 or, conversely, unloaded from cargo deck 12 of aircraft 10. A “ULD”, as used herein, includes a container, pallet, or other cargo of any size, shape, configuration, and/or type. In general, ULDs are available in various sizes and capacities, and are typically standardized in dimension and shape. Once loaded with items destined for shipment, ULD 20 is transferred to aircraft 10 and then loaded onto aircraft 10 through cargo load door 16 using a conveyor ramp, scissor lift or the like. As illustrated, ULD 20 is loaded laterally (e.g., the negative y-direction) into cargo compartment 14. Once inside aircraft 10, ULD 20 may be moved longitudinally (e.g., the x-direction) cargo compartment 14 to a final stowed position. Straps may be used to secure ULD 20 in the final stowed position to tend to minimize, or prevent, movement of ULD 20 during transport. Multiple ULDs may be brought on-board aircraft 10, with each ULD 20 being placed in a respective stowed position on cargo deck 12. One or more final ULDs 20 may be loaded laterally into cargo compartment 14 but not moved longitudinally within cargo compartment 14. After aircraft 10 has reached its destination, each ULD 20 is unloaded from aircraft 10 in similar fashion, but in reverse sequence to the loading procedure. To facilitate movement of ULD 20 along the cargo deck 12, aircraft 10 may include a cargo handling system as described herein in accordance with various embodiments.

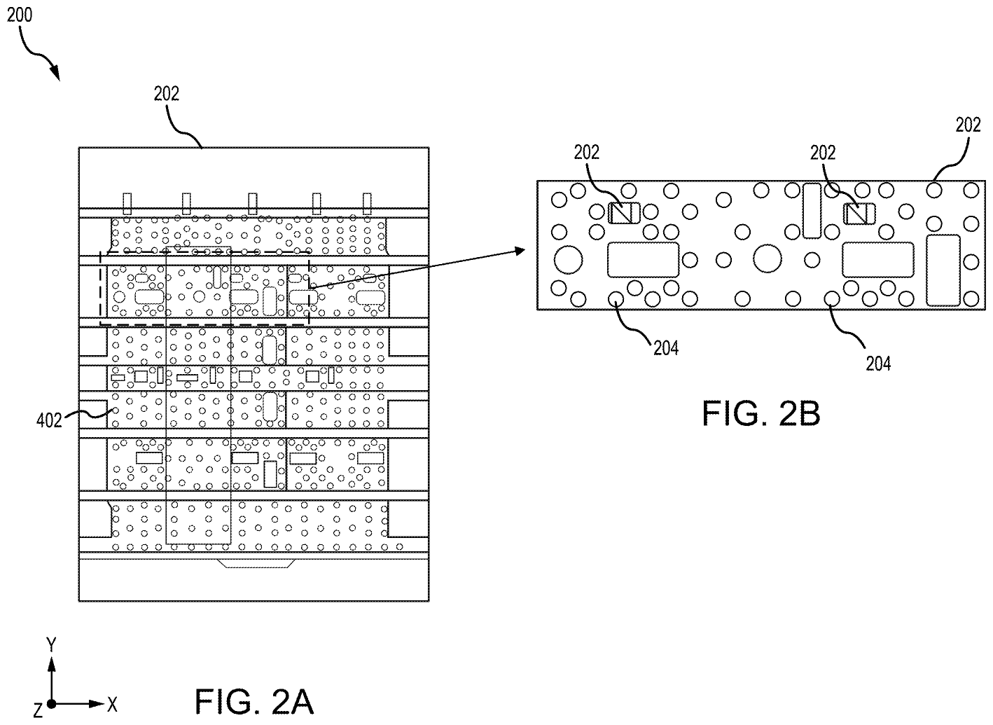

Referring now to FIGS. 2A-2B, in accordance with various embodiments, a cargo handling system 200 is illustrated. FIGS. 2A and 2B are a top-down views of cargo handling system 200. Cargo handling system 200 includes a ball panel 202 having a plurality of omni-directional rollers 204 and one or more auxiliary guide assemblies 206. Ball panel 202 may be located in cargo compartment 14, such as within the opening created by cargo load door 16. Ball panel 202 is configured to receive cargo (e.g., ULD 20) laterally within aircraft 10 (e.g., the negative x-direction) and move the cargo (e.g., ULD 20) longitudinally (e.g., the y-direction) within cargo compartment 14. Omni-directional roller 204 allows the cargo to move both laterally and longitudinally. That is, omni-directional roller 204 includes a ball that rotates as the cargo moves over top of the ball. In various embodiments, cargo handling system 200 may further include one or more power drive units (PDUs) configured to move the cargo along ball panel 202. For example, one or more PDUs may be configured to move the cargo laterally along ball panel 202 and one or more different PDUs may be configured to move the cargo longitudinally over ball panel 202.

Auxiliary guide assembly 206 is disposed in ball panel 202 and is configured to guide the cargo (e.g., ULD 20) as moves with cargo compartment 14. Auxiliary guide assembly 206 is configured to retract into (e.g., in the negative z-direction) ball panel 202 and extend out of (e.g., in the positive z-direction) ball panel 202. Auxiliary guide assembly 206 may fully retract into ball panel 202 in response to a first force (e.g., worker pushing down) and be locked in the retracted position. Auxiliary guide assembly 206 includes a locking mechanism that secures auxiliary guide assembly 206 in the fully retracted position until the locking mechanism is disengaged. In addition or in the alternative, auxiliary guide assembly 206 may partially retract into ball panel 202 in response to a second force (e.g., ULD 20) such that it automatically extends above ball panel 202 after the force is removed. Auxiliary guide assembly 206 includes springs configured to extend auxiliary guide assembly 206 above ball panel 202 from the partially retracted state in the absence of the second force. That is, auxiliary guide assembly 206 is generally extended out of ball panel 202. Auxiliary guide assembly 206 includes two guiding surfaces and two overriding surfaces. A first guiding surface is configured to prevent movement of the cargo in a first direction (e.g., the positive x-direction) and guide the cargo longitudinally (e.g., along the y-axis) within cargo compartment 14. A second guiding surface is configured to prevent movement of the cargo in a second direction (e.g., the positive y-direction) and guide the cargo laterally (e.g., along the x-axis) within cargo compartment. A first override surface is configured to partially retract auxiliary guide assembly 206 in response to the cargo moving in a third direction (e.g., the negative y-direction). A second override surface is configured to partially retract auxiliary guide assembly 206 in response to the cargo moving in a fourth direction (e.g., the negative x-direction).

As illustrated in FIGS. 2A and 2B, ball panel 202 is configured to receive the cargo from the right side (e.g., the positive x-direction) into cargo compartment 14. The cargo moves into cargo compartment 14 in the fourth direction (e.g., laterally, in the negative x-direction) and engages first override surface of auxiliary guide assembly 206. Auxiliary guide assembly 206 partially retracts into ball panel 202 in response to the cargo engaging first override surface. Auxiliary guide assembly 206 extends out of ball panel 202 after the cargo is passed, allowing auxiliary guide assembly 206 to guide the cargo longitudinally (e.g., along the y-axis) should the cargo engage the first guiding surface of auxiliary guide assembly.

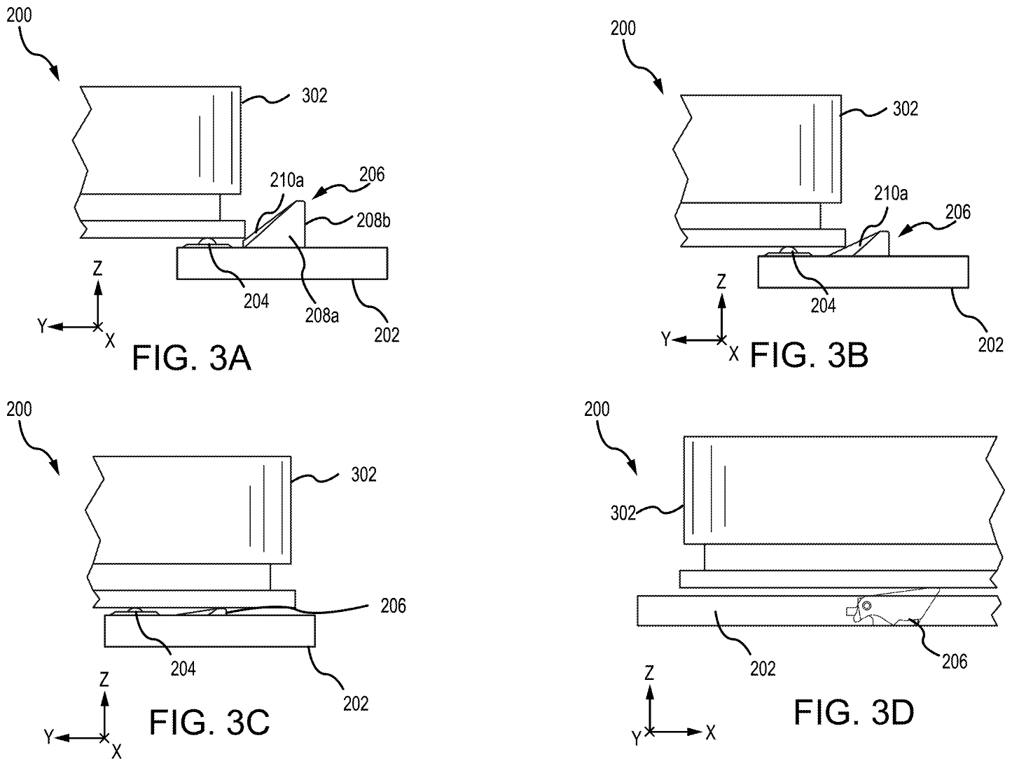

Referring now to FIGS. 3A-3D, a cargo handling system 200 including an auxiliary guide assembly 206 guiding a piece of cargo 302 is illustrated, in accordance with various embodiments. In various embodiments, cargo 302 may be a unit load device (ULD) such as ULD 20 described above with respect to FIG. 1. In various embodiments, cargo 302 may be a pallet or other type of cargo. As described above, auxiliary guide assembly 206 includes a first guiding surface 208a, a second guiding surface 208b, a first override surface 210a, and a second overriding surface. First guiding surface 208a is configured to guide prevent cargo 302 from moving in the first direction (e.g., the positive x-direction) and guide cargo 302 longitudinally (e.g., along the y-axis) within an aircraft (e.g., aircraft 10). Second guiding surface 208b is configured to prevent cargo 302 from moving in the second direction (e.g., the positive y-direction) and guide cargo 302 laterally (e.g., along the x-axis) within the aircraft. first override surface 210a is configured to allow cargo 302 to move in the third direction (e.g., the negative y-direction) by partially retracting auxiliary guide assembly (e.g., in the negative z-direction) into ball panel 202 in response to cargo 302 engaging first override surface in the third direction. Second override surface is configured to allow cargo 302 to move in the fourth direction (e.g., the negative x-direction) by partially retracting auxiliary guide assembly into ball panel 202 in response to cargo 302 engaging second override surface in the fourth direction.

FIG. 3A illustrates cargo 302 engaging first override surface 210a in the third direction (e.g., the negative y-direction). Cargo 302 rolls over omni-directional roller 204 and engages first override surface 210a of auxiliary guide assembly 206. first override surface 210a has an upward extending slope (e.g., in the positive z-direction) in the longitudinal direction (e.g., in the negative y-direction) that allows cargo 302 to move onto first override surface 210a that causes auxiliary guide assembly 206 to partially retract into ball panel 202. FIG. 3B illustrates cargo 302 moving onto first override surface 210a with auxiliary guide assembly 206 retracting into ball panel 202. FIG. 3C illustrates cargo 302 over top of auxiliary guide assembly 206 that is partially retracted into ball panel 202. FIG. 3D illustrated different view of auxiliary guide assembly partially retracted into ball panel 202.

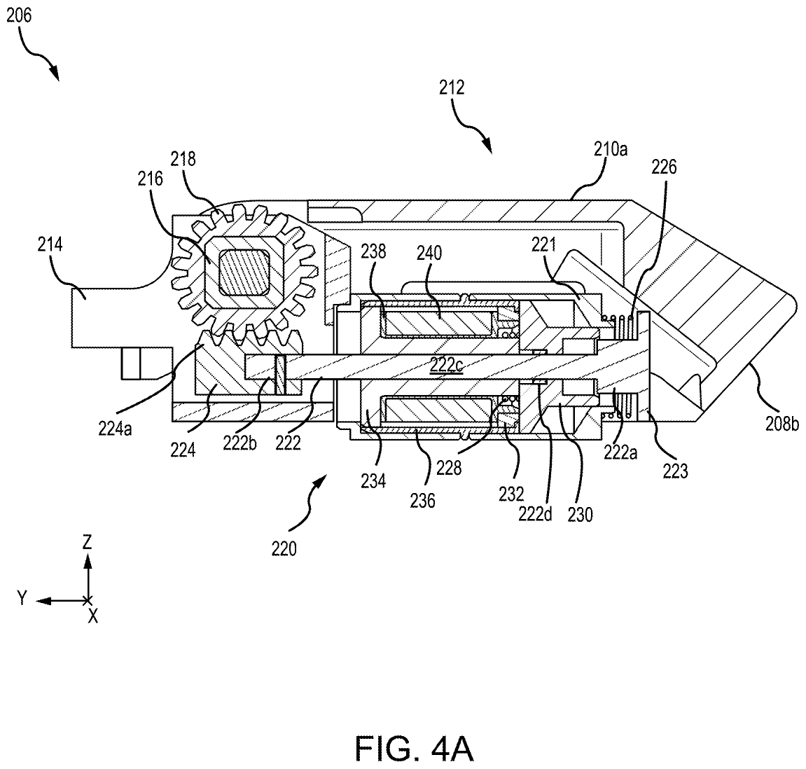

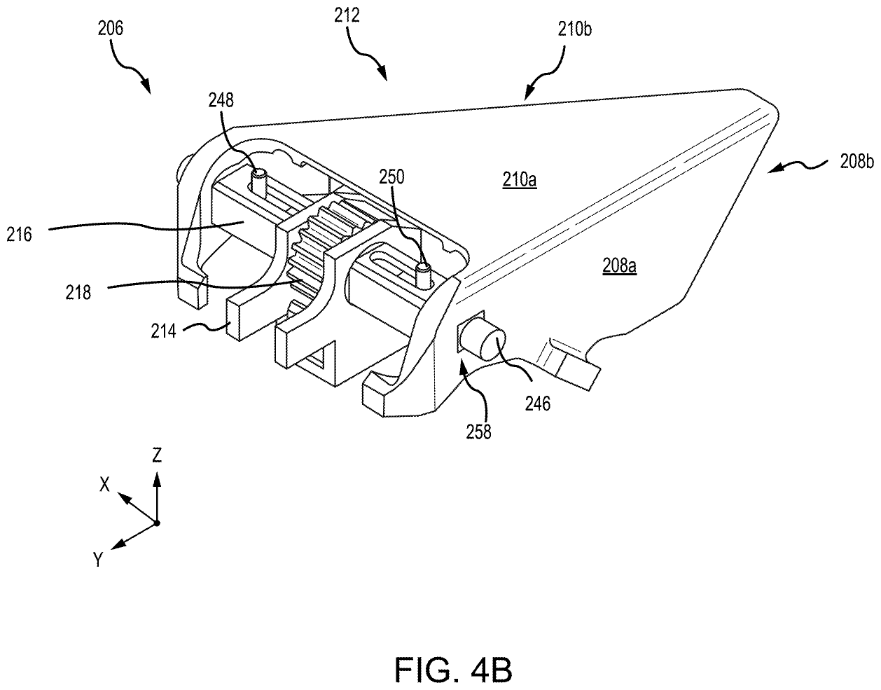

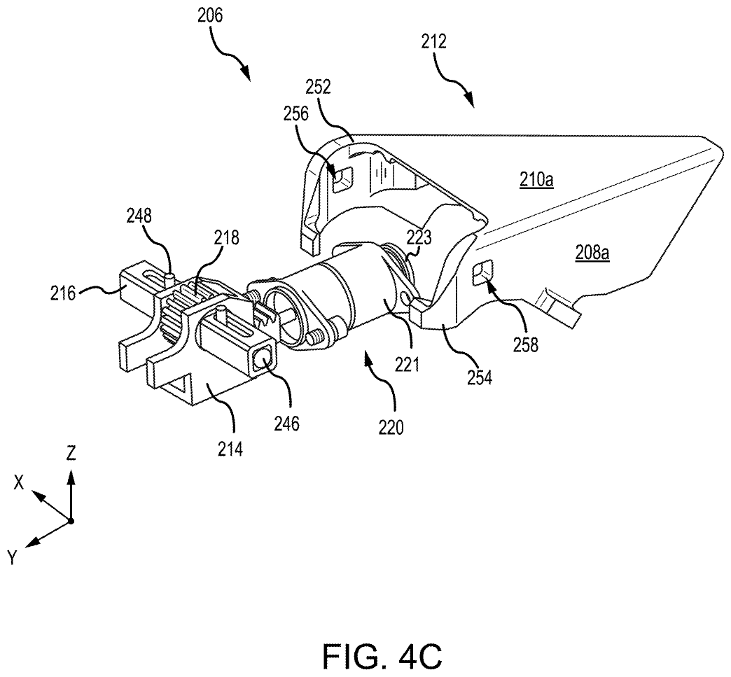

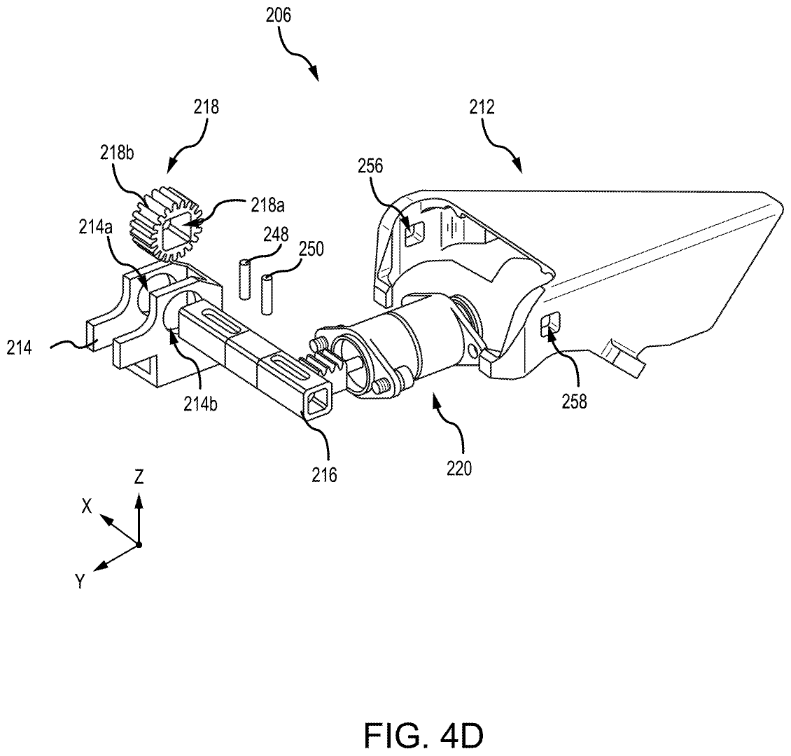

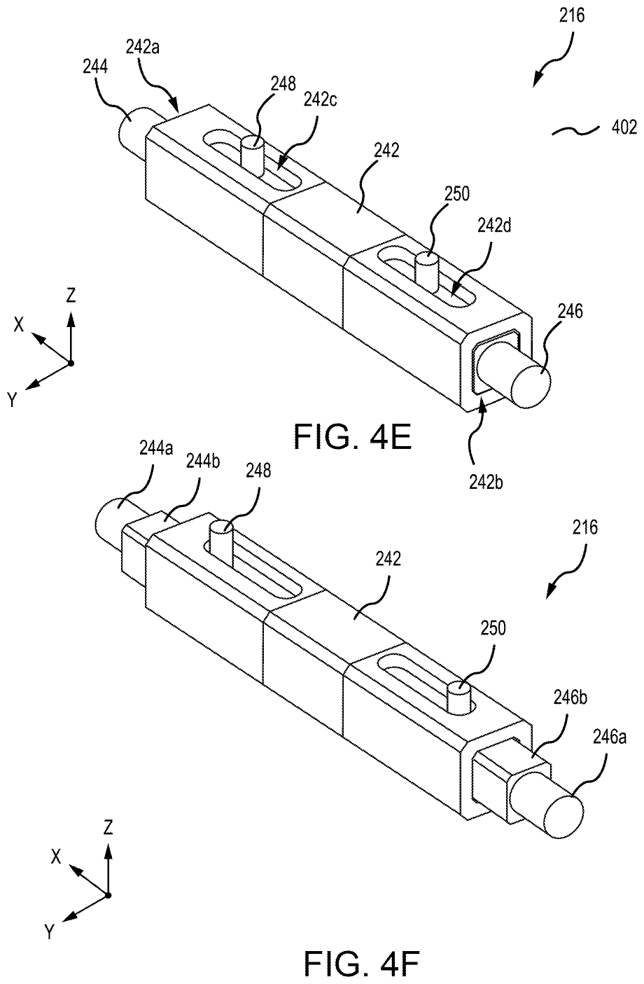

Referring now to FIGS. 4A-4F, an auxiliary guide assembly 206 is illustrated, in accordance with various embodiments. FIG. 4A is a cross section of auxiliary guide assembly 206. FIG. 4B is a perspective view of auxiliary guide assembly 206. FIGS. 4C and 4D are exploded perspective views of the components of auxiliary guide assembly 206. FIGS. 4E and 4F are perspective views of a union assembly that is a component in auxiliary guide assembly 206. Auxiliary guide assembly 206 includes a head 212, a hub 214, a union unit 216, a pinion 218 (aka gear), and a reciprocating latch solenoid 220.

Head 212 includes first guiding surface 208a, second guiding surface 208b, first override surface 210a, second override surface 210b, a first leg 252, a second leg 254, a first opening 256, and a second opening 258. First leg 252 extends in the third direction (e.g., the negative y-direction) from first guiding surface 208a and second leg 254 extends in the third direction from second override surface 210b. First opening 256 is formed in first leg 252 and second opening 258 is formed in second leg 254. In various embodiments, first opening 256 is in line with second opening 258 (e.g., along the x-axis). Head 212 is coupled to hub 214 and is configured to rotate (e.g., clockwise and anti-clockwise) with respect to the hub 214.

Hub 214 has a first opening 214a and a second opening 214b formed therethrough (as illustrated in FIG. 4D). In various embodiments, first opening 214a and/or second opening 214b may be circular in shape. Pinion 218 includes an opening 218a formed therethrough and gear teeth 218b located around an outer circumference. In various embodiments, opening 218a may be rectangular in shape. Hub 214 is configured to receive pinion 218 between first opening 214a and second opening 214b so that first opening 214a, opening 218a, and second opening 214b are inline. Union unit 216 is configured to slide through first opening 214a, opening 218a, and second opening 214b, securing pinion 218 to hub 214. Pinion 218, and more specifically, opening 218a is configured to engage union unit 216 to rotate union unit 216 in response to pinion 218 rotating.

Union unit 216 includes a body 242, a first lock pin 244, a second lock pin 246, a first slot pin 248, and a second slot pin 250. Body 242 has an axial length (e.g., along the x-axis) having a first opening 242a at a first axial end and a second opening 242b at a second axial end. Body 242 further includes a third opening 242c and a fourth opening 242d along a side of body 242. First lock pin 244 is configured to be inserted into first opening 242a of body 242 and second lock pin 246 is configured to be inserted into second opening 242b of body 242. First lock pin 244 includes a first portion 244a and a second portion 244b with second portion 244b being proximate body 242 and first portion 244a being distal body 242. In various embodiments, first portion 244a has a circular cross section. In various embodiments, second portion 244b has a rectangular cross section. Second lock pin 246 includes a first portion 246a and a second portion 246b with second portion 246b being proximate body 242 and first portion 246a being distal body 242. In various embodiments, first portion 246a has a circular cross section. In various embodiments, second portion 246b has a rectangular cross section.

In various embodiments, a first spring may be located in first opening 242a between first lock pin 244 and body 242. The first spring provides an outward force (e.g., in the positive x-direction) on first lock pin 244. In various embodiments, a second spring may be located in second opening 242b between second lock pin 246 and body 242. The second spring provides an outward force (e.g., in the negative x-direction) on second lock pin 246. First lock pin 244 is configured to receive first slot pin 248. First slot pin 248 may be inserted through third opening 242c into second portion 244b of first lock pin 244. First slot pin 248 retains first lock pin 244 in first opening 242a (as illustrated in FIG. 4F). Second lock pin 246 is configured to receive second slot pin 250. Second slot pin 250 may be inserted through fourth opening 242d into second portion 246b of second lock pin 246. Second slot pin 250 retains second lock pin 246 in second opening 242b (as illustrated in FIG. 4F).

Union unit 216 secures pinion 218 to hub 214, hub 214 to head 212, and auxiliary guide assembly 206 to ball panel 202 (as illustrated in FIG. 4B). Union unit 216 extends through first opening 214a of hub 214, opening 218a of pinion 218, and second opening 214b of hub 214 securing union unit 216 to hub 214. Pinion 218 engages union unit 216 so that pinion 218 is rotationally coupled to union unit 216. First lock pin 244 extends through first opening 256 of head 212 and second lock pin 246 extends through second opening 258 of head 212. When installed, second portion 244b of first lock pin 244 engages first opening 256 and second portion 246b of second lock pin 246 engages second opening 258 so that union unit 216 and head 212 are rotationally coupled. That is, union unit 216 and head 212 rotate in response to pinion 218 rotating. When installed, first portion 244a of first lock pin 244 and first portion 246a of second lock pin 246 engage ball panel 202, securing auxiliary guide assembly 206 to ball panel 202.

When auxiliary guide assembly 206 is installed in ball panel 202, first lock pin 244 and second lock pin 246 are fully extended with first portion 244a and first portion 246a engaging ball panel 202 and second portion 244b and second portion 246b engaging head 212. First slot pin 248 and second slot pin 250 are in corresponding positions, furthest from a center of body 242 (as illustrated in FIGS. 4B and 4F). Moving first slot pin 248 and second slot pin 250 inward (e.g., in the negative x-direction and the positive x-direction, respectively) retracts first lock pin 244 and second lock pin 246, respectively (as illustrated in FIG. 4E). In this position, second portion 244b and second portion 246b are retracted into body 242 and first portion 244a and first portion 246a are retracted from ball panel 202, allowing auxiliary guide assembly 206 to be removed from ball panel 202. Moving first slot pin 248 and second slot pin 250 further inward retracts first lock pin 244 and second lock pin 246 fully into body 242 (as illustrated in FIG. 4C). In this position, head 212 may be removed from auxiliary guide assembly 206.

Reciprocating latch solenoid 220 provides a motive force to rotate pinion 218, and in response, rotate union unit 216 and head 212. In various embodiments, reciprocating latch solenoid 220 provides a linear force that is converted to a rotational force by pinion 218. Reciprocating latch solenoid 220 includes a housing 221, a reciprocating rod 222, a rod head 223, a rack 224, an outer spring 226, an inner spring 228, an armature 230, a ring magnet 232, an inner static core 234, an outer static core 236, a spool 238, and a wire 240 that is wound around spool 238. Housing 221 encloses the components of solenoid 220, provides mounting features, and environmental protection for solenoid 220.

Reciprocating rod 222 extends through housing 221 and moves back and forth (e.g., along the y-axis) with respect to housing 221. Reciprocating rod 222 includes a first end 222a extending out a first end of housing 221, a second end 222b extending out a second end of housing 221, a shaft 222c extending from first end 222a to second end 222b, and tabs 222d along shaft 222c. Rod head 223 is coupled to first end 222a of reciprocating rod 222 and has a larger diameter than shaft 222c, preventing rod head 223 from entering housing 221. Second end 222b of reciprocating rod 222 is coupled to rack 224. Rack 224 includes gear teeth 224a that are configured to engage gear teeth 218b of pinion 218. The lateral back and forth movement of reciprocating rod 222 is converted to rotational movement of head 212 by rack 224 and pinion 218.

Inner static core 234, outer static core 236, spool 238, and wire 240 form the electrical components of solenoid 220. Spool 238 is located within housing 221 and between inner static core 234 and outer static core 236. Wire 240 is wound around spool 238 and is connected to an electric source. In various embodiments, the electric source may be cargo handling system 200. In various embodiments, the electric source may be aircraft 10. In various embodiments, the electric source may be a battery. Wire 240 generates a magnetic flux in response to receiving an electric current from electric power source. In other words, in response to solenoid 220 being energized (e.g., by an electric current), solenoid generates the magnetic flux. Inner static core 234 and outer static core 236 provide a path for the magnetic flux.

Outer spring 226 is located between housing 221 and first end 222a of reciprocating rod 222 with reciprocating rod 222 extending through outer spring 226. Outer spring 226 exerts a first force on reciprocating rod 222, and more specifically, on first end 222a to translate reciprocating rod away from housing 221 (e.g., in the negative y-direction).

Armature 230 is configured to move between an engaged position and a disengaged position. Armature 230 moves to the engaged position (e.g., in the positive y-direction) in response to solenoid 220 being engaged. Inner spring 228 is located inside housing 221 and between armature 230 on one side and inner static core 234 and outer static core 236 on the other side. Inner spring 228 exerts a second force on armature 230 to translate armature 230 to the disengaged position, away from inner static core 234 and outer static core 236 (e.g., in the negative y-direction).

Ring magnet 232 is located between inner static core 234 and outer static core 236 and adjacent armature 230. Ring magnet 232 is configured to hold armature 230 in the engaged position after solenoid 220 is disengaged. That is, in response to solenoid 220 being disengaged, ring magnet 232 exerts a third force (e.g., in the positive y-direction) on armature 230 that is stronger than the second force exerted by inner spring 228 on armature 230. Solenoid 220 creates a first magnetic flux that complements the third force of ring magnet 232 in response to a first electric current having a first polarity being applied. Solenoid 220 creates a second magnetic flux that is opposite the first magnetic flux and opposite the third force of ring magnet 232 in response to a second electric current having a second polarity that is opposite the first polarity being applied.

Reciprocating rod 222 extends through armature 230 and tabs 222d of reciprocating rod 222 are located between a portion of armature 230 and inner static core 234 and outer static core 236. Armature 230 is configured to engage tabs 222d to move reciprocating rod 222 inward (e.g., in the positive y-direction) but not outward (e.g., in the negative y-direction).

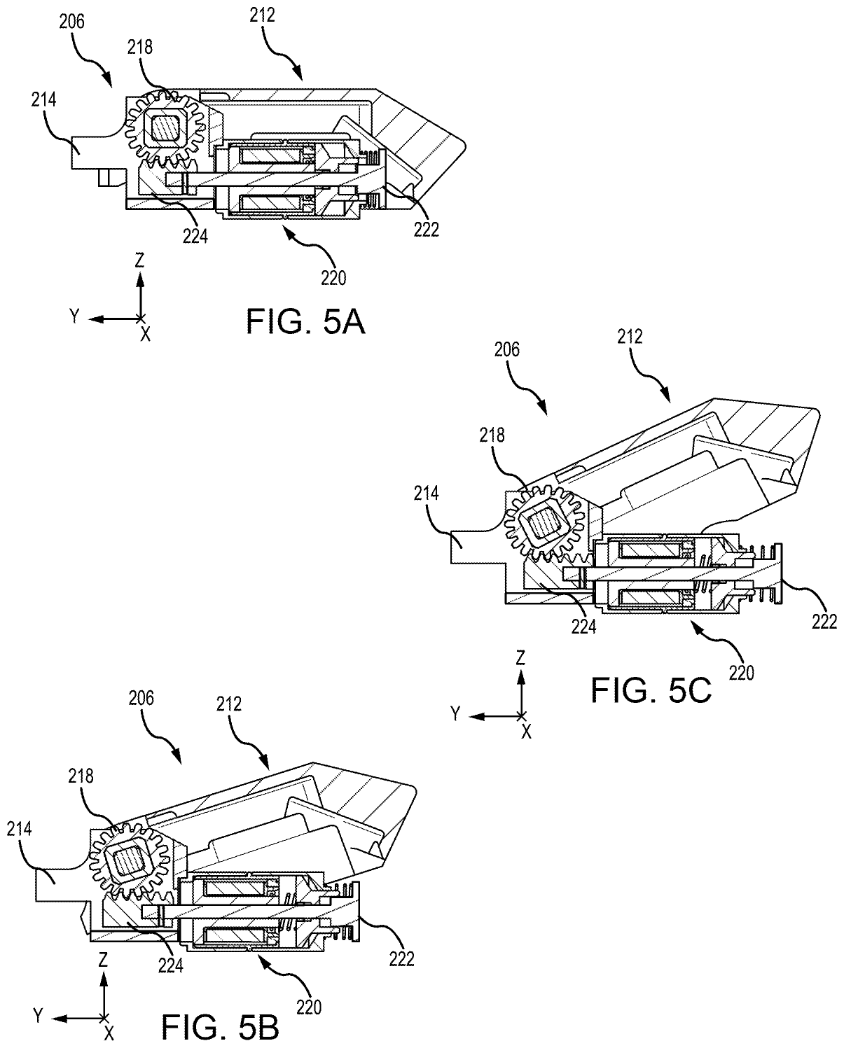

Referring now to FIGS. 5A-5C, three states of auxiliary guide assembly 206 are illustrated, in accordance with various embodiments. FIG. 5A illustrates auxiliary guide assembly 206 in a locked down state. FIG. 5B illustrated auxiliary guide assembly 206 in an up position. FIG. 5C illustrates auxiliary guide assembly 206 in an overriding position. Auxiliary guide assembly 206 includes all the components previously discussed above, including head 212, hub 214, union unit 216, pinion 218, solenoid 220, reciprocating rod 222, outer spring 226, inner spring 228, armature 230, and ring magnet 232.

Referring first to FIG. 5A, auxiliary guide assembly 206 is locked in the disengaged, down, or fully retracted position. Armature 230 is in the engaged position (e.g., moved in the positive y-direction) and securing reciprocating rod 222 in place by engaging tabs 222d. That is, armature 230 prevents reciprocating rod 222 from translating to the right (e.g., in the negative y-direction) which prevents pinion 218 and head 212 from rotating. In various embodiments, ring magnet 232 hold armature 230 in the engage position and auxiliary guide assembly 206 in the disengaged position without the aid of solenoid 220. In various embodiments, solenoid 220 is engaged, receiving a first electric current having a first polarity that augments ring magnet 232 and attracts armature 230.

Referring next to FIG. 5B, auxiliary guide assembly 206 is in the up, engaged, or guiding, position. Solenoid 220 is disengaged (i.e., not receiving an electric current) when auxiliary guide assembly 206 is in the up position. Solenoid 220 is engaged, receiving a second current having a second polarity that is opposite the first polarity to repel armature 230 to the right (e.g., the negative y-direction) to the disengaged position allowing head 212 to extend upward (e.g., in the positive z-direction). In various embodiments, inner spring 228 may aid in repelling armature 230. Solenoid 220 may then be disengaged, allowing reciprocating rod 222 to translate back and forth (e.g., along the y-axis). In this position, auxiliary guide assembly 206 may guide cargo (e.g., ULD 20) along a ball panel (e.g., ball panel 202).

Referring last to FIG. 5C, auxiliary guide assembly 206 is in the overriding, or partially retracted, position. In this position, cargo (e.g., ULD 20) is overriding, or moving over top of, auxiliary guide assembly 206. As the cargo moves over auxiliary guide assembly 206, and more specifically, over head 212, head 212 rotates downward (e.g., in the negative z-direction). Pinion 218 rotates clockwise in response to head 212 rotating downward which in turn causes rack 224 to translate to the left (e.g., the positive y-direction). The force of the cargo on head 212 overcomes the force exerted by outer spring 226 allowing reciprocating rod 222 to translate to the left (e.g., the positive x direction). After the cargo disengages with head 212, outer spring 226 pushes reciprocating rod 222, including rack 224, to the right (e.g., the negative y-direction). Pinion 218 rotates anti-clockwise in response to rack 224 moving thereby causing head 212 to raise up (e.g., in the positive z-direction).

As described herein, auxiliary guide assembly 206 may be raised and lowered remotely and without user intervention. This reduces the amount of workload by allowing a user to engage and disengage all auxiliary guide assemblies 206, either individually or collectively, at the same time. In various embodiments, power to auxiliary guide assembly 206 may be cut while auxiliary guide assembly 206 is in the disengaged, or down, position. In various embodiments, a tool may be used to engage pinion 218 and rotate pinion 218 thereby applying a force on rack 224 and reciprocating rod 222 to force armature 230 to move to the disengaged position (e.g., in the negative y-direction). That is, the force applied to pinion 218 by the tool may be sufficient to overcome ring magnet 232, thereby unlocking auxiliary guide assembly 206 for use.

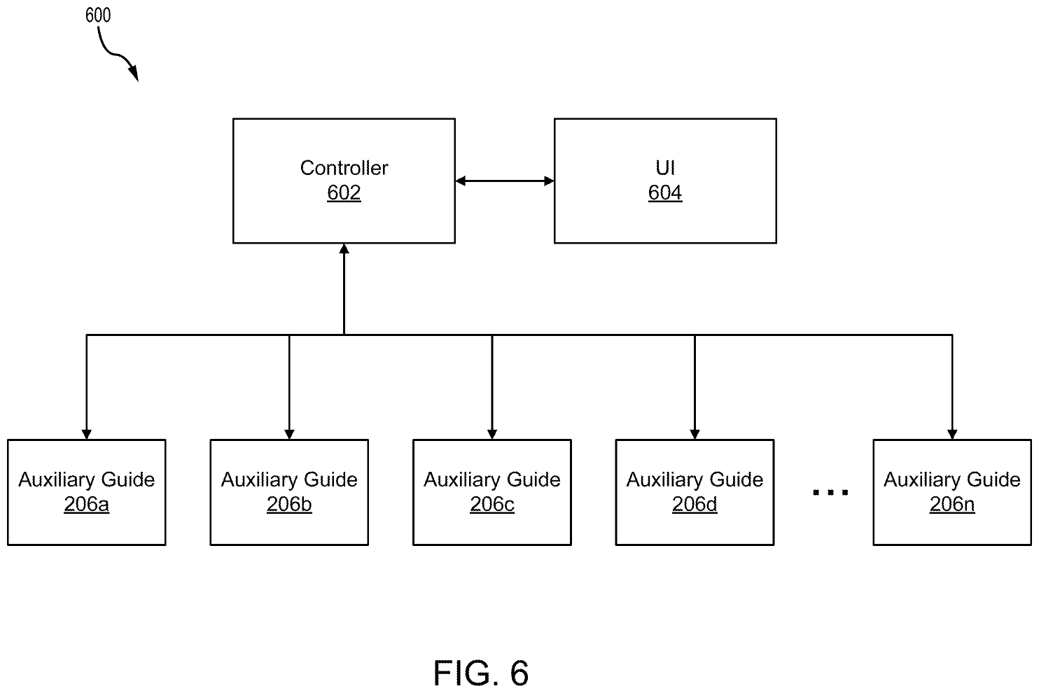

Referring to FIG. 6, a system 600 for controlling a plurality of auxiliary guide assemblies 206 is illustrated, in accordance with various embodiments. System 600 includes a controller 602, a user interface (UI) 604, and a plurality of auxiliary guide assemblies 206a, 206b, 206c, 206d, . . . , 206n, collectively referred to herein as auxiliary guide assemblies 206. In various embodiments, UI 604 may be a central computer running a program to control a cargo handling system (e.g., cargo handling system 200), including the plurality of auxiliary guide assemblies 206. In various embodiments, UI 604 may be a tablet, a phone, or a remote control, among other interfaces, for controlling the plurality of auxiliary guide assemblies 206 in the cargo handling system.

Controller 602 may be operatively coupled to UI 604 and to the plurality of auxiliary guide assemblies 206. In various embodiments, controller 602 may be connected to UI 604 and/or the plurality of auxiliary guide assemblies 206 via a wired connections such as ethernet, coaxial cable, universal serial bus (USB), serial (e.g., RS-232), controller area network (CAN) bus, or inter-integrated circuit (I2C) protocol, among others. In various embodiments, controller 602 may be connected to UI 604 and/or the plurality of auxiliary guide assemblies 206 by a wireless connection such as Wi-Fi, Bluetooth, Zigbee, Z-wave, or radio frequency (RF), among others.

In various embodiments, controller 602 may receive instructions from UI 604 for the plurality of auxiliary guide assemblies 206. In various embodiments, controller 602 may receive status from the plurality of auxiliary guide assemblies 206 to send to UI 604. In various embodiments, controller 602 may individually control each auxiliary guide assembly 206a, 206b, 206c, 206d, . . . , 206n. In various embodiments, controller 602 may collectively control (e.g., all at once) all the plurality of auxiliary guide assemblies 206.

Controller 602 may be configured to receive an instruction from UI 604 to engage one or more of the plurality of auxiliary guide assemblies 206 and send a signal to engage (e.g., solenoid 220) each of the one or more auxiliary guide assemblies 206. Controller 602 may further be configured to receive an instruction from UI 604 to disengage one or more of the plurality of auxiliary guide assemblies 206 and send a signal to disengage (e.g., solenoid 220) each of the one or more auxiliary guide assemblies 206. Controller 602 may be further configured to receive a status from one or more of the plurality of auxiliary guide assemblies 206 indicating the current state of each of the plurality of auxiliary guide assemblies 206. In various embodiments, each of auxiliary guide assemblies 206 may be in a fully retracted state, an operational state with the solenoid engaged, and an operational state with the solenoid disengaged, among others.

Controller 602 may comprise one or more processors configured to implement various logical operations in response to execution of instructions, for example, instructions stored on a non-transitory, tangible, computer-readable medium. The one or more processors can be a general purpose processor, a microprocessor, a microcontroller, a digital signal processor (DSP), an application specific integrated circuit (ASIC), a field programmable gate array (FPGA) or other programmable logic device, discrete or transistor logic, discrete hardware components, or any combination thereof. Controller 602 may further comprise memory to store data, executable instructions, system program instructions, and/or controller instructions to implement the control logic of controller 602.

System program instructions and/or controller instructions may be loaded onto a non-transitory, tangible computer-readable medium having instructions stored thereon that, in response to execution by a controller, cause the controller to perform various operations. The term “non-transitory” is to be understood to remove only propagating transitory signals per se from the claim scope and does not relinquish rights to all standard computer-readable media that are not only propagating transitory signals per se.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Numbers, percentages, or other values stated herein are intended to include that value, and also other values that are about or approximately equal to the stated value, as would be appreciated by one of ordinary skill in the art encompassed by various embodiments of the present disclosure. A stated value should therefore be interpreted broadly enough to encompass values that are at least close enough to the stated value to perform a desired function or achieve a desired result. The stated values include at least the variation to be expected in a suitable industrial process, and may include values that are within 5% of a stated value. Additionally, the terms “substantially,” “about” or “approximately” as used herein represent an amount close to the stated amount that still performs a desired function or achieves a desired result. For example, the term “substantially,” “about” or “approximately” may refer to an amount that is within 5% of a stated amount or value.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. An auxiliary guide assembly, comprising:
a head including a guiding surface and an overriding surface;
a pinion;
a hub configured to receive the pinion;
a union unit configured to secure the pinion to the hub, the union unit rotationally coupled to the pinion and the head;
a solenoid coupled to the hub, the solenoid configured to receive a first electric polarity;
a reciprocating rod disposed through the solenoid, the reciprocating rod having a first rod end including a rack operatively coupled to the pinion; and
an armature disposed adjacent the solenoid and configured to engage the reciprocating rod, wherein the armature is configured to move in a first direction in response to the solenoid receiving the first electric polarity, the armature moving the reciprocating rod in the first direction, and the head is configured to rotate in a second direction in response to the reciprocating rod moving in the first direction.

2. The auxiliary guide assembly of claim 1, wherein the solenoid is further configured to receive a second electric polarity that is opposite the first electric polarity, wherein the armature is configured to move in a third direction that is opposite the first direction in response to the solenoid receiving the second electric polarity, and the head is configured to rotate in a fourth direction in response to the armature moving in the second direction, the fourth direction being opposite the second direction.

3. The auxiliary guide assembly of claim 1, further comprising:
an inner spring disposed between the armature and the solenoid, the inner spring configured to move the armature in a third direction that is opposite the first direction; and
a ring magnet configured to hold the armature in first position.

4. The auxiliary guide assembly of claim 1, further comprising:
a first opening in the head having a first rectangular cross section;
a second opening in the hub having a circular cross section; and
a third opening in the pinion having a second rectangular cross section, the union unit disposed through the first opening, the second opening, and the third opening.

5. The auxiliary guide assembly of claim 1, further comprising:
a rod head disposed at a second rod end of the reciprocating rod that is opposite the first rod end; and
an outer spring disposed between the rod head and the armature, wherein the outer spring is configured to move the rod head in a third direction that is opposite the first direction.

6. The auxiliary guide assembly of claim 1, the union unit further comprising:
a body having a first end, a second end, and a first side extending from the first end to the second end;
a first opening in the first end;
a second opening in the second end;
a first lock pin disposed in the first opening; and
a second lock pin disposed in the second opening, wherein the first lock pin and the second lock pin are configured to engage the head.

7. The auxiliary guide assembly of claim 6, wherein the first lock pin has a first portion and a second portion, the first portion having a circular cross section and the second portion having a rectangular cross section.

8. A cargo handling system, comprising:
a ball panel for moving and storing cargo, the ball panel having a top surface; and
an auxiliary guide assembly disposed within the ball panel, the auxiliary guide assembly including:
a head configured to rotate in a first direction to extend above the top surface and rotate in a second direction to retract below the top surface, the second direction being opposite the first direction;
a rack and pinion coupled to the head, the pinion causing the head to rotate in the first direction and the second direction; and
a solenoid magnetically coupled to the rack, the solenoid causing the rack to move in a first linear direction and a second linear direction, wherein the head rotates in the first direction in response to the rack moving in the first linear direction.

9. The cargo handling system of claim 8, the auxiliary guide assembly further comprising:
a reciprocating rod coupled to the rack, the reciprocating rod extending through the solenoid;
an armature configured to engage the reciprocating rod, the armature disposed adjacent the solenoid wherein the solenoid is configured to move the armature in the first linear direction in response to a first electric polarity; and
an inner spring disposed between the solenoid and the armature, the inner spring configured to move the armature in the second linear direction.

10. The cargo handling system of claim 9, the auxiliary guide assembly further comprising:
a rod head coupled to the reciprocating rod; and
an outer spring disposed between the rod head and the armature, the outer spring configured to move the rod head in the second linear direction.

11. The cargo handling system of claim 9, the auxiliary guide assembly further comprising:
a ring magnet disposed between the solenoid and the armature, the ring magnet configured to hold the armature in a first position in response to the solenoid receiving the first electric polarity.

12. The cargo handling system of claim 11, wherein the solenoid is configured to move the armature in the second linear direction in response to a second electric polarity that is opposite the first electric polarity.

13. The cargo handling system of claim 8, wherein the rack moves in the second linear direction in response to the head rotating in the second direction.

14. The cargo handling system of claim 8, the auxiliary guide assembly further comprising:
a hub configured to receive the pinion; and
a union unit coupled to the hub, the pinion, and the head, wherein the union unit is rotationally coupled to the pinion and the head.

15. A system, comprising:
a ball panel having a top surface;
a first auxiliary guide assembly disposed in the ball panel, the first auxiliary guide assembly including a head configured to raise above the top surface and retract below the top surface;
a user interface;
a processor operatively connected to the first auxiliary guide assembly and to the user interface; and
a memory operatively coupled to the processor, the memory comprising instructions stored thereon that, when executed by the processor, cause the processor to:
receive a first instruction from the user interface; and
send a first electric polarity to the first auxiliary guide assembly in response to the first instruction, the head raising above the top surface in response to the first electric polarity.

16. The system of claim 15, wherein the instructions, when executed by the processor, further cause the processor to:
receive a second instruction from the user interface; and
send a second electric polarity to the first auxiliary guide assembly in response to the second instruction, the head retracting below the top surface in response to the second electric polarity, the second electric polarity being opposite the first electric polarity.

17. The system of claim 15, the first auxiliary guide assembly further comprising:
a solenoid configured to receive the first electric polarity;
a rack magnetically coupled to the solenoid, the rack configured to move linearly in a first direction in response to the solenoid receiving the first electric polarity; and
a pinion coupled to the head and the rack, the pinion translating a linear motion of the rack to a rotational motion of the head.

18. The system of claim 17, the first auxiliary guide assembly further comprising:
a reciprocating rod coupled to the rack and extending through the solenoid;
a ring magnet disposed adjacent the solenoid; and
an armature configured to engage the reciprocating rod, the armature configured to move in the first direction to a first position in response to the solenoid receiving the first electric polarity, the ring magnet holding the armature in the first position in an absence of the first electric polarity.

19. The system of claim 15, further comprising:
a second auxiliary guide assembly disposed in the ball panel, wherein the processor is operatively coupled to the second auxiliary guide assembly, and wherein the instructions, when executed by the processor, further cause the processor to:
receive a second instruction from the user interface, the second instruction identifying the second auxiliary guide assembly; and
send the first electric polarity to the second auxiliary guide assembly independent of the first auxiliary guide assembly.

20. The system of claim 19, wherein the user interface is configured to engage and disengage the first auxiliary guide assembly and the second auxiliary guide assembly.
